(19) United States
(12) Patent Application Publication
(10) Pub. No.: US 2024/0418320 A1
(43) Pub. Date: Dec. 19, 2024

(54) CRYOGENIC CONTAINER WITH THERMAL BRIDGE SWITCH

(71) Applicants: Cryoshelter LH2 GmbH, Dobl-Zwaring (AT); Cryoshelter BioLNG GmbH, Dobl-Zwaring (AT)

(72) Inventor: Matthias REBERNIK, Dobl-Zwaring (AT)

(21) Appl. No.: 18/691,172

(22) PCT Filed: Sep. 15, 2022
(86) PCT No.: PCT/EP2022/075607

§ 371 Date: Mar. 12, 2024

(30) Foreign Application Priority Data
Sep. 15, 2021 (AT) GM 50188/2021

(51) Int. Cl. F17C 3/08

(52) U.S. Cl. CPC F17C 3/08; F17C 2201/0109; F17C 2203/0391; F17C 2203/0629; F17C 2205/0332; F17C 2205/0352; F17C 2221/012; F17C 2223/0161; F17C 2227/0355; F17C 2250/032; F17C 2250/0473; F17C 2250/0631; F17C 2265/066; F17C 2270/0168

(57) ABSTRACT

A cryogenic container, in particular a hydrogen container, including an inner container and an outer container enclosing the inner container, with a cooling layer being arranged between the inner container and the outer container, the cooling layer enveloping the inner container at least partially and being insulated with respect to both the inner container and the outer container, with a removal line being routed through the inner container as well as through the cooling layer and the outer container, thereby passing through them, where the device comprises a thermal bridge switch configured to establish a contact between the cooling layer and the removal line in a closed position so as to form a thermal bridge and further configured to separate the cooling layer from the removal line in an opened position so as to eliminate the thermal bridge.

### BACKGROUND AND RELEVANT ART

The invention relates to a device comprising a cryogenic container, in particular a hydrogen container, comprising an inner container and an outer container enclosing the inner container, with a cooling layer being arranged between the inner container and the outer container, the cooling layer enveloping the inner container at least partially and being insulated with respect to both the inner container and the outer container, with a removal line being routed through the inner container as well as through the cooling layer and the outer container, thereby passing through them.

According to the prior art, liquefied gases can be stored in containers (“cryogenic containers”) so as to be stored as a fuel for an engine, for example. Liquefied gases are gases that are in the liquid state at boiling temperature, with the boiling temperature of this fluid being pressure-dependent. If such a cryogenic liquid is filled into a cryogenic container, a pressure corresponding to the boiling temperature is established, apart from thermal interactions with the cryogenic container itself.

In the application field of automotive engineering, the cryogenic fluid can serve as a fuel for a vehicle, for which purpose the cryogenic container is carried along on the vehicle. Cryogenic containers are usually mounted on the side of the vehicle frame, and the cryogenic containers must have enough insulation capacity so that the cryogenic fluid will remain in the cryogenic container at a low temperature for as long as possible, since those containers are not actively cooled, at least when the vehicle is at a standstill.

For example, hydrogen at a temperature of up to −253° C. is filled into the cryogenic container, with the cryogenic fluid located in the cryogenic container steadily heating up due to the constant heat input into the cryogenic container, whereby the pressure in the cryogenic container rises as well. As soon as the pressure in the cryogenic container exceeds a certain threshold, gaseous cryogenic fluid is discharged from the container for the purpose of pressure reduction. It is evident that the endeavour is made to improve the insulation capacity of the cryogenic container in order to reduce the heat input therein so that the time span after which cryogenic fluid is discharged from the cryogenic container is increased.

It is therefore known from the prior art to create the cryogenic container with an inner container and an outer container that is vacuum-insulated relative to the inner container. Special further developments such as those disclosed, for example, in AT 504 888 B1 provide for insulating shells usually made of metal to be provided between the inner container and the outer container. On the one hand, these have the purpose of serving as radiation shields and, on the other hand, of providing a thermal mass. This additional thermal mass can be kept at the temperature of the cryogenic fluid when the vehicle is in operation and absorbs the first heat input after the vehicle has been switched off, whereby the cryogenic fluid stays cold for longer.

### BRIEF SUMMARY

It is now the object of the invention to further develop and optimize such cryogenic containers with cooling layers between the inner container and the outer container.

In a first aspect of the invention, this object is achieved by a device which comprises a cryogenic container, in particular a hydrogen container, comprising an inner container and an outer container enclosing the inner container, with a cooling layer being arranged between the inner container and the outer container, the cooling layer enveloping the inner container at least partially and being insulated with respect to both the inner container and the outer container, with a removal line being routed through the inner container as well as through the cooling layer and the outer container, thereby passing through them, the device comprising a thermal bridge switch designed for establishing a contact between the cooling layer and the removal line in a closed position so as to form a thermal bridge and for separating the cooling layer from the removal line in an opened position so as to eliminate the thermal bridge.

The thermal bridge switch allows for the first time that a heat transfer between the cooling layer and the removal line can be selectively generated and separated. This can especially be used for cooling the cooling layer as quickly as possible when cryogenic fluid is removed from the cryogenic container or, respectively, for preventing any heat input into the cooling layer once there is no more cryogenic fluid to be removed from the cryogenic container in order to keep the cooling layer cold for as long as possible. This is due to the fact that, regardless of the temperature of the removal line, no heat can flow from the removal line into the cooling layer or, vice versa, from the cooling layer into the removal line, depending on which component may have the higher temperature at the respective time. In this way, an attachment point becomes possible even regardless of the temperature profile of the removal line and improves the overall packaging of the system. Without a thermal bridge switch, the connection would indeed have to be made at the point on the removal line where said line has the same temperature as the shield, otherwise, so-called “mistaken heat flows” become large and the insulation quality worsens.

By means of the two aforementioned functions of the thermal bridge switch, it can be achieved that the so-called hold time is extended, i.e., the time span from the end of the removal until the point in time at which the pressure in the cryogenic container reaches a predefined threshold. If the thermal bridge switch were not provided, it would be necessary either to provide a permanent thermal bridge between the cooling layer and the removal line, whereby the cooling layer would heat up too quickly upon completion of the removal, or to never provide a thermal bridge between the cooling layer and the removal line, which, however, would prevent the cooling layer from being cooled by extracted cryogenic fluid. Both problems are overcome by the invention.

In a preferred embodiment, the cooling layer is a rigid metal shield, preferably an aluminium shield, or a single-layer or multi-layer metal foil and preferably has a greater thickness at the end caps of the cryogenic container than at an area between the end caps. If the cooling layer is a multi-layer metal foil, the thermal bridge switch can connect one or more than one metal foil to the removal line. The greater thickness of the cooling layer at the end caps enables the space available between the inner container and the outer container to be optimally utilized in order to increase the mass of the cooling layer.

In the simplest case, the thermal bridge switch can be operated manually. In a particularly preferred embodiment, however, the device comprises a control unit which is designed for closing the thermal bridge switch when cryogenic fluid is removed from the cryogenic container via the removal line and for opening the thermal bridge switch as soon as the removal of cryogenic fluid from the cryogenic container via the removal line is stopped. The control unit can be designed, for example, in the form of electronics with, e.g., electromechanically or hydraulically operated actuators or as a purely mechanical or hydraulic logic. The control unit can be implemented with particular ease if it only has the function of closing the thermal bridge switch when the vehicle is in operation, e.g., if an appropriate control signal is applied to a control line of the control unit. In the simplest case, the control unit can thus be integrated into the thermal bridge switch and the latter can be designed as a normally open switch. In other preferred embodiments, the control unit closes the thermal bridge switch even if there is no active removal, but boil-off gas escapes via the removal line.

For closing the thermal bridge switch in case of the escape of boil-off gas, the control unit can have different designs. On the one hand, the control unit could permanently receive measured values, for example about a pressure in the cryogenic container, or a separate control line could be routed from the pressure relief valve in the removal line via which the boil-off gas is discharged to the control unit, and the control unit could close the thermal bridge switch when the pressure relief valve opens.

For example, a pressure relief valve can be provided in the removal line or in a boil-off line connected to the removal line or routed into the cryogenic container, and a control line is routed from the pressure relief valve to the control unit via which the triggering of the pressure relief valve can be indicated, and the control unit is designed for closing the thermal bridge switch when the pressure relief valve is opened. Options for indicating the triggering of a pressure relief valve in an electrical or currentless fashion are known per se to those skilled in the art, see, for example, EP 3 489 062 A1.

Upon completion of the removal, there is usually no power so that the control unit cannot perform any complex calculations after the active removal has ended. The following solutions come to mind especially in this case. On the one hand, it is furthermore preferred if the control unit is designed for closing the thermal bridge switch after a predetermined period of time upon completion of the removal. Assumptions can be made and evaluated as to when boil-off gas will emerge from the cryogenic container, and thus it can be specified, for example, in the control unit that the thermal bridge switch should re-close after 48 hours upon completion of the removal.

However, the point in time can be determined much more precisely by a control unit that is designed for determining a hold time of the cryogenic container, the hold time being the time span from the end of the removal until the point in time at which the pressure in the cryogenic container reaches a predefined threshold, with the control unit being designed for closing the thermal bridge switch when the hold time is reached upon completion of the removal. For example, the control unit can continuously calculate the current hold time of the cryogenic container during the active removal of cryogenic fluid and can constantly update the time after which the thermal bridge switch should be closed, since the hold time depends especially on the current fill level.

Alternatively or additionally, a sensor unit for detecting a mass flow can be provided in the removal line, and the thermal bridge switch is closed when cryogenic fluid flows through the removal line and is closed when no cryogenic fluid flows through the removal line.

Basically, the mechanical design of the thermal bridge switch can be chosen arbitrarily. However, it is preferred if the thermal bridge switch comprises at least one connecting element made of metal, which particularly preferably comprises a copper mesh surrounding the removal line or in the closed state of the thermal bridge switch, wherein the connecting element is connected only to the cooling layer in the opened state of the thermal bridge switch and is connected to both the cooling layer and the removal line in the closed state, or wherein the connecting element is connected only to the removal line in the opened state of the thermal bridge switch and is connected to both the cooling layer and the removal line in the closed state.

A problem in some embodiments is that no current source is available when the vehicle is not in operation. In this case, current is not always available when the thermal bridge switch is to be closed or, respectively, opened. It may therefore be preferred, especially in the case of the thermal bridge switch not closing when boil-off gas exits the cryogenic container, if the device furthermore comprises a boil-off line separate from the removal line and comprising a valve that opens at a predetermined overpressure, wherein the boil-off line is routed through the inner container as well as through the cooling layer and the outer container, thereby passing through them, and is in a heat-conducting connection with the cooling layer at least over a length of 0.2 m, 0.5 m or 0.8 m and has a cross-sectional area which corresponds at most to half (or at most to 20%, 40%, 60% or 80%) of the cross-sectional area of the removal line, wherein the diameter of the boil-off line can preferably be a maximum of 10 mm, a maximum of 6 mm or a maximum of 4 mm, regardless of this. The boil-off line thus forms a permanent but small thermal bridge with the cooling layer, whereby the cooling layer can be cooled independently of the current when boil-off gas exits the cryogenic container in order to transfer heat from the cooling layer to the boil-off gas. Basically, this embodiment could even be implemented without a thermal bridge switch.

It is preferred if the cryogenic container has a longitudinal axis which preferably forms an axis of rotation of the cryogenic container, with the removal line passing through an end cap of the cryogenic container that is arranged essentially normal to the longitudinal axis. As an alternative, the removal line could also pass through the lateral surface.

Generally, the device brings about significant improvements for cryogenic containers of all types. However, particularly preferably, a vehicle with an engine and a device according to any of the aforementioned embodiments is provided, with the removal line being connected to the engine for supplying cryogenic fluid as a fuel for the engine.

In a second aspect, the invention relates to a computer program product for a device according to any of the aforementioned embodiments, comprising commands which, when the program is executed by a computer, prompt the latter to perform the following steps:
opening the thermal bridge switch when no cryogenic fluid flows through the removal line;
closing the thermal bridge switch when cryogenic fluid flows through the removal line, at least when cryogenic fluid is actively removed through the removal line and preferably also when cryogenic fluid is discharged from the cryogenic container through the removal line after a predetermined maximum pressure has been reached in the cryogenic container via the removal line.

It is irrelevant for the computer program product as to whether the opening or closing step is provided first. In a third aspect, the invention generally relates to a method in which said opening and closing steps are performed.

### BRIEF DESCRIPTION OF THE DRAWINGS

Advantageous and non-limiting embodiments of the invention are explained in further detail below with reference to the drawings.

FIG. 1 shows the device according to the invention in a first embodiment.

FIG. 2 shows the device according to the invention in a second embodiment.

FIG. 3a shows a circuit diagram of the thermal bridge switch according to the invention.

FIG. 3b shows a diagram of the pressure in the cryogenic container associated with FIG. 3a.

FIG. 4 shows the device according to the invention in a third embodiment.

FIG. 5 shows the device according to the invention in a fourth embodiment.

### DETAILED DESCRIPTION

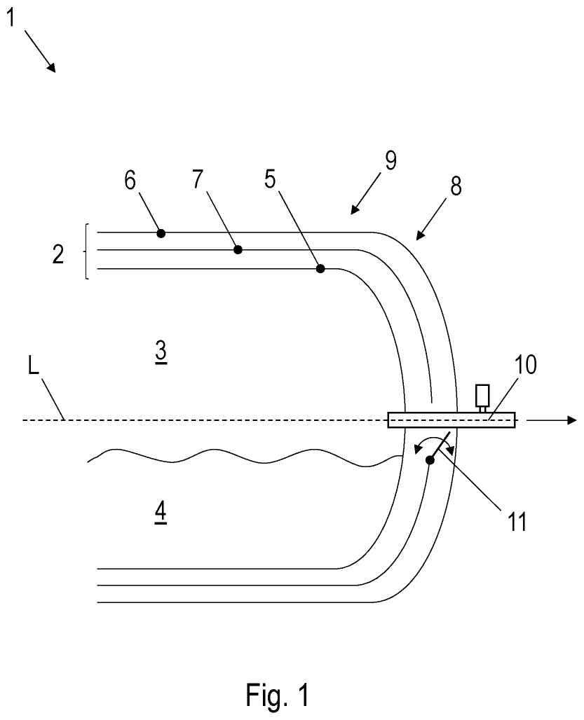

FIG. 1 shows a device 1 comprising a cryogenic container 2 in which cryogenic fluid in the gaseous state 3 or in the liquid state 4 is stored. For example, the cryogenic fluid can be hydrogen so that the cryogenic container 2 is a hydrogen container, or the cryogenic fluid can be LNG (Liquefied Natural Gas) so that the cryogenic container is an LNG container. Depending on the cryogenic fluid, the cryogenic container is therefore designed for storing cryogenic fluid at temperatures of, for example, below 150 Kelvin, in case of hydrogen even of below 50 Kelvin or below 30 Kelvin or essentially of 20 Kelvin. Depending on the application, the cryogenic container 2 could be designed, for example, for storing sLH2 (subcooled liquid hydrogen) or CcH2 (cryo-compressed hydrogen) and thus also for corresponding high pressures, for example for maximum pressures of between 5 bar and 350 bar.

In order to keep the cryogenic fluid at low temperatures for as long as possible and to reduce the heat input into the cryogenic container 2, the cryogenic container 2 has an inner container 5 and an outer container 6 spaced apart therefrom on all sides. A vacuum can thereby be provided between the inner container 5 and the outer container 6.

Furthermore, the cryogenic container 2 comprises a cooling layer 7 that is known per se and is insulated both with respect to the inner container 5 and with respect to the outer container 6. In the simplest case, the cooling layer 7 is a rigid, i.e., self-supporting, metal shield, e.g., a metal sheet which is appropriately spaced apart from the inner container 5 and the outer container 6. The insulation of the metal shield with respect to the inner container 5 and the outer container 6 is thereby effected via the aforementioned vacuum. The cooling layer 7 can be a single layer or a multi-layer element such as an MLI (multi-layer insulation) wherein several metal foils, usually aluminium foils, are separated by poorly heat-conducting intermediate layers such as paper layers, glass fibre layers, etc. In a further embodiment, the cooling layer 7 can be a carbon layer vapour-plated with aluminium or a textile made of aluminium wire and/or glass fibre coated with aluminium. Therefore, the cooling layer 7 typically comprises metal for heat conduction, although other materials could also be used.

According to the invention, the cooling layer 7 serves, on the one hand, as a radiation shield and, on the other hand, as a thermal storage. If the cooling layer 7 is at the temperature of the cryogenic fluid, the cooling layer 7 will heat up first, before the cryogenic fluid heats up, in the event of heat being introduced from the outside. For this reason, it is also preferred if the thermal mass of the cooling layer 7 is as large as possible. For example, as mentioned above, the cooling layer 7 can be designed for this purpose as a rigid metal shield, i.e., as a metal sheet and in particular as an aluminium sheet or a copper sheet with a thickness of at least 0.1 mm, preferably of at least 0.5 mm, preferably of essentially 0.75 mm. For example, an aluminium sheet with a total mass of 10-20 kg can be used. Particularly preferably, for increasing the thermal mass, the cooling layer 7 can have a thickness also at end caps 8 of the cryogenic container 2 that is greater than at an area between the end caps 8. For example, a rigid metal shield can have a thickness of 0.75 mm in the jacket area and a thickness of 3 mm in the end cap area, wherein the transition can be continuous. The area between the end caps 8 is usually designed as a jacket 9 extending in the direction of a longitudinal axis L of the cryogenic container 2.

As a result of the thermal conductivity of the cooling layer 7, especially if it is made of aluminium or copper, heat introduced at any point can be distributed quickly across the entire cooling layer 7. Due to the insulation of the cooling layer 7 with respect to the inner container 5 and the outer container 6, it can thus be said that the thermal conductivity of the cooling layer 7 around the circumference of the cryogenic container 2 is significantly greater than into the cryogenic container 2, for example, at least 100,000 times or at least 1,000,000 times greater.

The cryogenic container 2 described herein is usually used as a fuel tank of a vehicle (not illustrated any further) and can be mounted for this purpose, for example, on the vehicle frame of the vehicle. For supplying the cryogenic fluid as a fuel to an engine of the vehicle, a removal line 10 is routed into the cryogenic container 2. The removal line 10 thereby passes through the cryogenic container 2, i.e., the removal line 10 passes through the inner container 5, the outer container 6 and the cooling layer 7 located between them. If the cooling layer 7 does not completely enclose the inner container 5, if it has, for example, an annular recess in the middle of the cryogenic container 2, the removal line 10 could be routed from the inner container 5 to the outer container 6 also in the area of the recess, which is herein understood to mean that the removal line 10 passes through the cooling layer 7.

As shown in FIG. 1, the removal line 10 can pass through one of the end caps 8 and can run, for example, normal to the longitudinal axis L. In other embodiments, the removal line 10 can also pass through the jacket 9 and can run radially, for example, normal to the longitudinal axis L of the cryogenic container 2.

It is apparent from FIG. 1 that a so-called thermal bridge switch 11 is located at the interface between the cooling layer 7 and the removal line 10. It is a characteristic of the thermal bridge switch 11 that it establishes a contact between the cooling layer 7 and the removal line 10 in a closed position so as to form a thermal bridge and separates the cooling layer 7 from the removal line 10 in an opened position so as to eliminate the thermal bridge. The physical design of the thermal bridge switch 11 can be achieved in a variety of ways, some of which are explained below.

The thermal bridge switch 11 enables that no thermal bridge exists between the cooling layer 7 and the removal line 10 in the opened state. The purpose of this is that, after heating, the cooling layer 7 should not transfer the heat directly to the cryogenic fluid via the removal line 10 or, respectively, the removal line 10 should transfer it directly from the outer container 6 into the cooling layer 7. For example, the vehicle with the cryogenic container 2 can be switched off. The heat input from the outside now heats the cooling layer 7, however, due to the opened thermal bridge switch 11, this heat is not released directly to the removal line 10 and thus to the cryogenic fluid. As a result, it is possible to increase the time after which the cryogenic fluid in the cryogenic container 2 reaches a certain temperature and thus a certain pressure upon completion of the final removal.

In the closed state, the thermal bridge switch 11 allows cryogenic fluid emerging from the cryogenic container 2 to absorb heat from the cooling layer 7, thus discharging it from the cryogenic container 2. The closing of the thermal bridge switch 2 thus serves for cooling the cooling layer 7. It is evident that the thermal bridge switch should only be closed if cryogenic fluid flows through the removal line 10.

The thermal bridge switch 11 is thus movable between the closed position and the opened position. For example, the thermal bridge switch 11 can thereby be operated manually, e.g., a user of the vehicle can open the thermal bridge switch 11 after ending the journey with the vehicle and can close the thermal bridge switch 11 at the start of the journey.

Alternatively or additionally, the thermal bridge switch 11 can be opened and closed automatically. For example, the thermal bridge switch 11 can be designed as a normally open switch, and a control line of the thermal bridge switch 11 can be connected to the engine, electronics of the vehicle and/or electronics of the cryogenic container 2 (which, for example, controls an economizer and/or a pressure management system of the cryogenic container 2). If a signal indicating the operation of the vehicle and thus the removal of cryogenic fluid from the cryogenic container 2 is now applied to the control line, a current is applied to the thermal bridge switch 11, whereby said switch is closed. For this purpose, a switching logic, which can be regarded as a simple control unit, can be implemented in the thermal bridge switch 11.

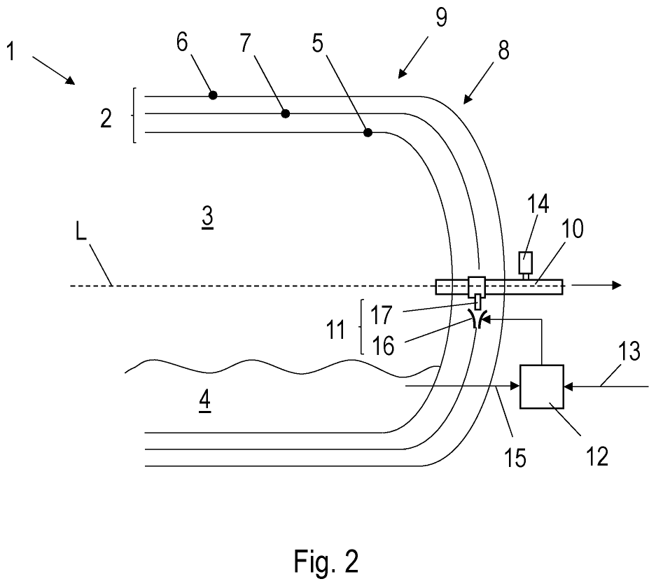

FIG. 2 shows an embodiment in which the control unit 12 is designed separately from the thermal bridge switch 11. The control unit 12 controls the thermal bridge switch 11 in a wired or wireless manner. For example, the control unit 12 can be connected to the engine or, respectively, to electronics of the vehicle or the cryogenic container 2 via a control line 13 and can open or, respectively, close the thermal bridge switch 11 depending on a signal received via the control line 13.

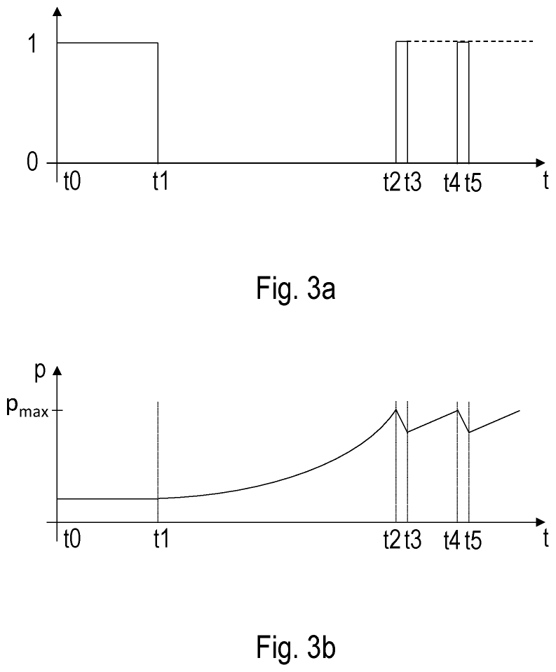

With reference to FIGS. 3a and 3b, possible switching states of the thermal bridge switch 11 will now be explained. FIG. 3a shows the switching state of the thermal bridge switch 11 on the vertical axis, with “1” denoting the closed state and “0” denoting the opened state. The time t is plotted on the horizontal axis. FIG. 3b shows a pressure p in the cryogenic container 2 on the vertical axis, with pₘₐₓ denoting a maximum permissible pressure in the cryogenic container 2. The time t is plotted on the horizontal axis.

In the example illustrated in FIGS. 3a and 3b, active removal of cryogenic fluid from the cryogenic container 2 occurs at point in time t0 and continues until point in time t1. This removal corresponds, for example, to a journey of the vehicle on which the cryogenic container 2 is mounted. During the period of time t0-t1, the thermal bridge switch 11 remains closed and the temperature in the cryogenic container 2 and thus the pressure in the cryogenic container 2 substantially remain consistently low, i.e., at a level below the activation pressure of a pressure relief valve or, respectively, at a pressure which is sufficient for the drive mode. The cryogenic fluid flowing through the removal line 10 cools the cooling layer 7 via the closed thermal bridge switch 11.

At the point in time t1 of the completion of the removal of cryogenic fluid from the cryogenic container 2, the thermal bridge switch 11 is opened in order to prevent heat absorbed by the cooling layer 7 from being released to the cryogenic fluid located in the cryogenic container 2. If the thermal bridge switch 11 were closed, heat would additionally be introduced into the cooling layer 7 through the connection path supplementary in the closed state, namely thermal bridge switch—removal line—inner container, or respectively, through the path outer container—removal line—thermal bridge switch, whereby heating would occur more quickly than with the thermal bridge switch being opened, which is due to the freedom of local attachment as created by the thermal bridge switch 11. However, it is evident from FIG. 3b that the temperature of the cryogenic fluid in the cryogenic container 2 slowly increases and thus the pressure therein rises, too. This is due to other unavoidable thermal bridges, heat radiation from the cooling layer 7, etc. The pressure rises at the beginning more slowly than later, since the cooling layer 7 is still cold at the beginning, and, therefore, the heat input from the cooling layer 7 into the cryogenic fluid is initially slower, which is the desired effect. This effect is also related to the mass of the cooling layer 7, because the larger the mass of the cooling layer 7, the greater the delay in heating. Since the cryogenic container 2 is designed for a maximum permissible pressure pₘₐₓ, it usually has a pressure relief valve 14 which is connected to the removal line 10 and is activated if the pressure in the cryogenic container 2 reaches the maximum permissible pressure pₘₐₓ, which, in the illustrated example, happens at point in time t2. It is evident from FIG. 3b that the pressure in the cryogenic container 2 drops if the pressure relief valve 14 releases cryogenic fluid from the cryogenic container 2 as a so-called boil-off gas over the period of time t2-t3.

It can preferably be envisaged that the thermal bridge switch 11 re-closes at point in time t2, as illustrated in FIG. 3a. The reason for this is that the boil-off gas can cool the cooling layer 7 that has been heated over the period of time t1-t2 again over the period of time t2-t3, since the boil-off gas escapes via the removal line 10.

It can be summarized that the thermal bridge switch 11 can close when the pressure in the cryogenic container 2 reaches a predefined threshold. This can be implemented in various ways, for example via a sensor on the pressure relief valve which detects the opening of the pressure relief valve. For example, the pressure relief valve can directly generate a mechanical, electrical or hydraulic signal which closes the thermal bridge switch 11, if necessary also without a control unit 12. Alternatively or additionally, various assumptions can be made, and the control unit 12 can open the thermal bridge switch 11 after a predetermined time span upon completion of the removal, for example, a specific numerical value for the expected time span t1-t2 can be stored in advance in the control unit 12.

Furthermore, the control unit 12 can be designed for determining a hold time of the cryogenic container 2, the hold time being the time span from the end of the removal to the point in time at which the pressure in the cryogenic container 2 reaches a predefined threshold, with the control unit 12 being designed for closing the thermal bridge switch 11 when the hold time is reached upon completion of the removal. For example, during the journey, i.e., during the period of time t0-t1, the control unit 12 continuously determines the current hold time, which can be calculated, for example, from the current fill level, pressure and/or temperature, for which purpose the control unit 12 can receive appropriate measured values via a measured value line 15. In case the control unit 12 now determines at the point in time t1 that the removal has been finished, the control unit 12 can use the last determined hold time and can open the thermal bridge switch 11 after this time.

In the embodiments in which the control unit 12 opens the thermal bridge switch 11 after a predetermined or, respectively, calculated time span, it is advantageous that essentially no current is required over the period of time t1-t2. Actually, as a rule, no current will be available over the period of time t1-t2, since the vehicle is switched off and not in operation during this period of time. The current necessary for opening the thermal bridge switch 11 at the point in time t2 can be provided, for example, via a capacitance or the like. In these embodiments, the thermal bridge switch 11 is closed at the point in time t2 and, for example, remains closed indefinitely, which is indicated by the dashed line. In this case, the advantages of cooling using the boil-off gas outweigh the disadvantages of the heat input through the negative thermal bridge present from point in time t3, via the thermal bridge switch 11.

In another embodiment, the control unit 12 could also be supplied with power after point in time t1, via a battery, for example. In this embodiment, the control unit 12 could, for example, continuously receive measured values about a pressure in the cryogenic container 2 and could actuate the thermal bridge switch 11 specifically, i.e., could close the thermal bridge switch 11 over the period of time t2-t3 or, respectively, t4-t5 in case of an escape of boil-off gas and could open it over a period of time t3-t4, since, at this point in time, no cooling boil-off gas escapes, which is illustrated in FIG. 3a with the solid lines in the period of time t2-t5. The control unit 12 could receive the information as to whether boil-off gas emerges from the removal line 10 not only via measured pressure values, but also through a flow meter or temperature sensor arranged in the removal line 10 or via a control line which is connected to the pressure relief valve 14 and indicates the opening or, respectively, closing of the pressure relief valve 14.

Even if no power is available, the aforementioned control unit 12 can be implemented, for example, if the control unit 12 comprises a pneumatic control line which is connected to the thermal bridge switch 11 and the cryogenic container 12 or, respectively, the pressure relief valve 14 and which closes the thermal bridge switch 11 as soon as or, respectively, shortly before or shortly after the maximum permissible pressure pₘₐₓ is/has been reached, and wherein the pneumatic control line re-opens the thermal bridge switch 11 if the pressure drops below a predetermined pressure or a predetermined time span has been reached.

In all the aforementioned embodiments, a computer, which is preferably implemented in the above-mentioned control unit 12, can be designed for running a computer program which actuates the thermal bridge switch 11 as follows:
opening the thermal bridge switch 11 when no cryogenic fluid flows through the removal line 10;
closing the thermal bridge switch 11 when cryogenic fluid flows through the removal line 10, at least when cryogenic fluid is actively removed through the removal line 10 and preferably also when cryogenic fluid is discharged from the cryogenic container 2 through the removal line 10 after a predetermined maximum pressure has been reached in the cryogenic container 2 via the removal line 10.

As already mentioned above, the thermal bridge switch 11 can be designed in a variety of ways. In particular, the thermal bridge switch 11 can comprise a connecting element made of metal, which can swivel as shown in FIG. 1. Alternatively, the connecting element could be guided on a linear guide. In FIG. 2, it is shown that the connecting element can comprise a copper mesh 16, which, in the closed state, could encompass a pin 17 connected to the removal line 10 or the removal line 10 itself. In the opened state, the copper mesh 16 can then be detached from the pin 17 or, respectively, the removal line 10.

Usually, it is envisaged that the connecting element is connected only to the cooling layer 7 in the opened state of the thermal bridge switch 11 and is connected to both the cooling layer 7 and the removal line 10 in the closed state, or vice versa. Furthermore, it would also be possible for the connecting element to be separated from both the cooling layer 7 and the removal line 10 in the opened state.

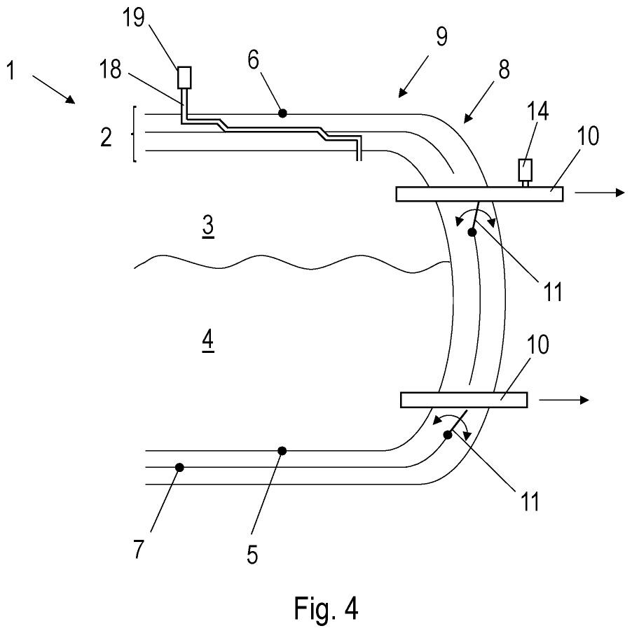

FIG. 4 shows a further embodiment in which two removal lines 10 are provided. Both removal lines 10 are designed with a thermal bridge switch 11, as described above, and can be selectively and independently connected to the cooling layer 7 in order to produce two different thermal bridges. What is special is that one removal line 10 is routed into the space of the cryogenic container 2 which, in the operating position, is at the top in order to remove cryogenic fluid in the gaseous state, and the other removal line 10 is routed into the space of the cryogenic container 2 which, in the operating position, is at the bottom in order to remove cryogenic fluid in the gaseous state. The two thermal bridge switches 11 can be actuated independently, for example, depending on via which removal line 10 cryogenic fluid is currently being removed. Boil-off gas will usually emerge only from the removal line 10 for the gaseous cryogenic fluid so that the control for closing the thermal bridge switch 11 upon completion of the removal is provided only for this thermal bridge switch 11. A common control unit 12 can be provided for both thermal bridge switches 11.

In order to design the device in a structurally particularly simple manner, it can also be envisaged that the thermal bridge switch 11 will not close after the active removal has ended, if boil-off gas escapes. In these cases, a boil-off line 18 separate from the removal line 10 and comprising a valve 19 could be provided, as schematically shown in FIG. 4, the valve 19 being a pressure relief valve and opening at a predetermined overpressure, wherein the boil-off line 18 is routed through the inner container 5 as well as through the cooling layer 7 and the outer container 6, thereby passing through them, and is connected to the cooling layer 7 at least over a length of 0.2 m, 0.5 m or 0.8 m and has a cross-sectional area which is at most half (or at most 20%, 40%, 60% or 80%) of the cross-sectional area of the removal line. Regardless of the removal line, the boil-off line 18 can, for example, have a diameter of a maximum of 10 mm, a maximum of 6 mm or a maximum of 4 mm. The length over which the boil-off line 18 is connected to the cooling layer 7 indeed results in a permanent thermal bridge, which is kept as small as possible due to the small diameter. At the same time, however, the thermal bridge contributes through the boil-off line 18 to the fact that escaping boil-off gas can cool the cooling layer 7. Due to the small diameter, the boil-off line 18 is not suitable for removing cryogenic fluid for the operation of an engine, but only for discharging cryogenic fluid for the purpose of pressure reduction. This extra line 18 is a solution for utilizing the cooling effect of the boil-off gas despite the lack of power when the vehicle is switched off, if necessary also together with a thermal bridge switch 11. In this embodiment, the thermal bridge switch could close, for example, only in the event of an active removal of cryogenic fluid.

Moreover, it is evident from FIG. 4 that the boil-off line 18 does not directly attach to the cooling layer 7 after passing through the inner container 5 so as not to form a direct thermal bridge. Similarly, the boil-off line 18 is decoupled from the cooling layer 7 within the insulated area over a predetermined distance before the latter exits the outer container 6 so as not to form a direct thermal bridge. With the thermal bridge switch 11, this restriction does not exist, whereby freedom of local attachment is achieved.

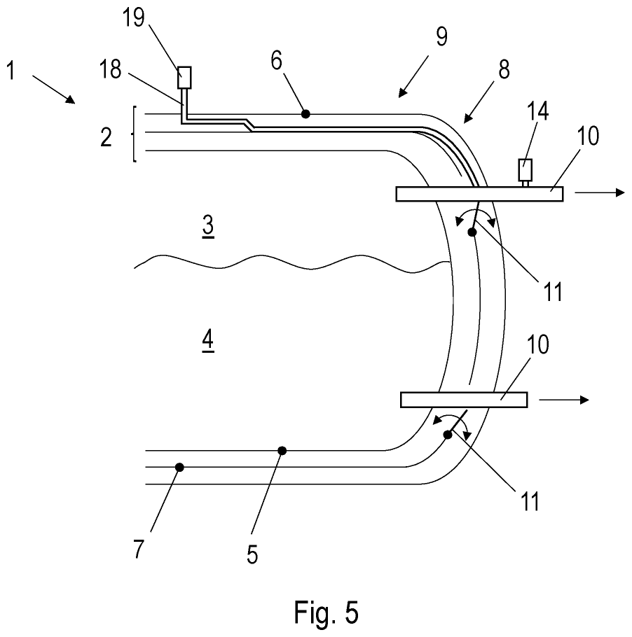

FIG. 5 shows an alternative to FIG. 4, wherein the boil-off line 18 does not pass through the inner container 5 as an independent line, but is attached to the removal line 10 in the insulated area between the inner container 5 and the outer container 6. Also in this case, the removal line 10 is connected to the cooling layer 7 at least over a length of 0.2 m, 0.5 m or 0.8 m and has a diameter of a maximum of 10 mm, a maximum of 6 mm or a maximum of 4 mm. In this case, too, the boil-off line 18 does not directly stop at the cooling layer 7 after branching off from the removal line 10 so as not to form a direct thermal bridge. Similarly, the boil-off line 18 is decoupled from the cooling layer 7 within the insulated area over a predetermined distance before the latter exits the outer container 6 so as not to form a direct thermal bridge.

Such embodiments with a separate boil-off line 18 could also be designed without a thermal bridge switch 11. In this case, it is preferably envisaged that the removal line 10 is always insulated with respect to the cooling layer 7, i.e., that there is no thermal bridge between this removal line 10 and the cooling layer 7, with the removal line 10 being routed through the cooling layer 7 over the shortest possible distance, for example, perpendicular through it. In summary, this results in a device 1 comprising a cryogenic container 2, in particular a hydrogen container, comprising an inner container 5 and an outer container 6 enclosing the inner container 5, with a cooling layer 7 being arranged between the inner container 5 and the outer container 6, the cooling layer enveloping the inner container 5 at least partially and being insulated with respect to both the inner container 5 and the outer container 6, with a removal line 10 being routed through the inner container 5 as well as through the cooling layer 7 and the outer container 6, thereby passing through them, furthermore comprising a boil-off line 18 separate from the removal line 10 and comprising a valve 19 that opens at a predetermined overpressure, wherein the boil-off line 18 is attached to the removal line 10 in the insulated area between the inner container 5 and the outer container 6 and is routed through the inner container 5 as well as through the cooling layer 7 and the outer container 6, thereby passing through them, and is connected to the cooling layer 7 at least over a length of 0.2 m, 0.5 m or 0.8 m and has a cross-sectional area which corresponds at most to half of the cross-sectional area of the removal line and/or wherein the diameter of the boil-off line is preferably a maximum of 10 mm, a maximum of 6 mm or a maximum of 4 mm.

1-10. (canceled)

11. A device comprising a cryogenic container, in particular a hydrogen container, comprising an inner container and an outer container enclosing the inner container, with a cooling layer being arranged between the inner container and the outer container, the cooling layer enveloping the inner container at least partially and being insulated with respect to both the inner container and the outer container,
with a removal line being routed through the inner container as well as through the cooling layer and the outer container, thereby passing through them, and
wherein the device comprises a thermal bridge switch configured to establish a contact between the cooling layer and the removal line in a closed position so as to form a thermal bridge and further configured to separate the cooling layer from the removal line in an opened position so as to eliminate the thermal bridge.

12. A device according to claim 11, wherein the cooling layer is a rigid metal shield, or a single-layer or multi-layer metal foil, and has a greater thickness at end caps of the cryogenic container than at an area between the end caps.

13. A device according to claim 11, furthermore comprising a control unit which is configured to close the thermal bridge switch when cryogenic fluid is removed from the cryogenic container via the removal line and is further configured to open the thermal bridge switch as soon as the removal of cryogenic fluid from the cryogenic container via the removal line is stopped, wherein the control unit closes the thermal bridge switch not only when an active removal of cryogenic fluid from the removal line exists, but also when boil-off gas escapes through the removal line.

14. A device according to claim 13, wherein the control unit is configured to close the thermal bridge switch after a predetermined period of time upon completion of the removal, and/or wherein the control unit is configured to determine a hold time of the cryogenic container, the hold time being a time span from the end of the removal until a point in time at which the pressure in the cryogenic container reaches a predefined threshold, with the control unit being configured to close the thermal bridge switch when the hold time is reached upon completion of the removal.

15. A device according to claim 13, wherein a pressure relief valve is provided in the removal line or in a boil-off line connected to the removal line or routed into the cryogenic container, and a control line is routed from the pressure relief valve to the control unit via which the triggering of the pressure relief valve can be indicated, and the control unit is configured to close the thermal bridge switch when the pressure relief valve is opened.

16. A device according to claim 11, wherein the thermal bridge switch comprises a connecting element made of metal, which comprises a copper mesh surrounding the removal line in the closed state of the thermal bridge switch, wherein the connecting element is connected only to the cooling layer in the opened state of the thermal bridge switch and is connected to both the cooling layer and the removal line in the closed state, or vice versa.

17. A device according to claim 11, furthermore comprising a boil-off line comprising a valve that opens at a predetermined overpressure, wherein the boil-off line is in a heat-conducting connection with the cooling layer at least over a length of 0.2 m, 0.5 m or 0.8 m, and has a cross-sectional area which corresponds to at most half of the cross-sectional area of the removal line, wherein the boil-off line has a diameter of a maximum of 10 mm, a maximum of 6 mm, or a maximum of 4 mm.

18. A device according to claim 1, wherein the cryogenic container has a longitudinal axis which forms an axis of rotation of the cryogenic container, with the removal line passing through an end cap arranged essentially normal to the longitudinal axis or through a jacket of the cryogenic container that is located between end caps.

19. A vehicle comprising an engine and a device according to claim 11, wherein the removal line is connected to the engine for supplying cryogenic fluid as a fuel for the engine.

20. A non-transitory storage medium for a device according to claim 11, and the non-transitory storage medium having stored therein instructions that are executable by one or more hardware processors to perform operations comprising:
opening the thermal bridge switch when no cryogenic fluid flows through the removal line; and
closing the thermal bridge switch when cryogenic fluid flows through the removal line, at least when cryogenic fluid is actively removed through the removal line and also when cryogenic fluid is discharged from the cryogenic container through the removal line after a predetermined maximum pressure has been reached in the cryogenic container via the removal line.
